(19) United States
(12) Patent Application Publication
(10) Pub. No.: US 2009/0210451 A1
(43) Pub. Date: Aug. 20, 2009

(54) CONTENT REALIZATION ENGINES

(75) Inventor: James Woodroffe, Boston, MA (US)

Correspondence Address: EDWARDS ANGELL PALMER & DODGE LLP, P.O. BOX 55874, BOSTON, MA, 02205, US

(73) Assignee: INTERACTION MEDIA GROUP, INC., Cambridge, MA (US)

(21) Appl. No.: 12/388,619

(22) Filed: Feb. 19, 2009

Related U.S. Application Data
(60) Provisional application No. 61/066,332, filed on Feb. 20, 2008.

(51) Int. Cl. G06F 17/30

(52) U.S. Cl. 707/104.1; 707/100; 707/E17.044

(57) ABSTRACT

A method for creating Web pages with a content realization engine embodied in a computer includes the steps of creating and storing primary content that is generally applicable, and inserting shims in the primary content, each shim being a placeholder for secondary content. The method creates and stores secondary content that is applicable to a specific topic. By combining the primary and secondary content, e.g., by replacing the shims with secondary content, a Web site directed to the specific topic is formed.

### CROSS-REFERENCE TO RELATED APPLICATION

This application claims priority to U.S. Provisional Patent Application No. 61/066,332, filed Feb. 20, 2008, which is incorporated herein by reference.

### BACKGROUND OF THE INVENTION

1. Field of the Invention

The subject disclosure relates to methods and systems for tailoring and presenting content to end users via a distributed computing network, and more particularly to improved methods and systems for merging primary and secondary content specific to a specified geographic area, industry, or the like.

2. Background of the Related Art

As the information age progresses, certain aspects of the world as we know it grow smaller. Sitting in the glow of a computer screen, an individual can instantaneously access information on the opposite side of the planet. However, the actual geographic range over which we travel in a day has changed little over the recent decades. Indeed, as fossil fuel prices rise, many look to remain in increasingly smaller geographic circles.

Computing and interconnected communication capability have revolutionized we navigate through these geographic circles by virtue of their integration into the daily activities of individuals. From electronic vehicle navigation systems to text updates, traditional practices such as pulling into a service station for directions and reading a newspaper are falling by the wayside.

Despite the wealth of information that the Internet offers, the information is generalized in that a user in California, USA views the same page as a user in Australia. Similarly, hedge fund managers and municipal bond investors access the same financial Web pages and see the same information, which is disadvantageously not tailored for review by either.

### SUMMARY OF THE INVENTION

In view of the above, a need exists for a content realization engine that provides tailored content according to region, industry, or a like criteria as well as the ability to seamlessly present and update such content. The content realization engine would also allow.

The present disclosure is directed to a method for creating Web pages with a content realization engine embodied in a computer. The method includes the steps of creating and storing primary content that is generally applicable, and inserting shims in the primary content, each shim being a placeholder for secondary content. The method creates and stores secondary content that is applicable to a specific topic. By combining the primary and secondary content, e.g., by replacing the shims with secondary content, a Web site directed to the specific topic is formed.

Still another embodiment of the present disclosure includes an engine embodied in a computer for tailoring content to a specific purpose. The content realization engine includes a source for primary content, a primary content repository storing the primary content, a source for secondary content, a secondary content repository for storing the secondary content, and a content generation module to create a primary page having at least one shim that can be replaced with a portion of the secondary content to form at least one specific Web page.

It should be appreciated that the subject technology can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 is a flowchart of a process for regionalizing content in accordance with the subject technology.

FIGS. 2A-F are an exemplary Web page of primary content in accordance with the subject technology.

FIGS. 3A-D are an exemplary Web page of final content related to the Web page of FIGS. 2A-F in accordance with the subject technology.

### DETAILED DESCRIPTION OF PREFERRED EMBODIMENTS

The subject technology overcomes many of the prior art problems associated with presenting tailored content to on-line viewers. The advantages, and other features of the content realization engines disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

### Definitions

A computer means one or more digital data processing devices used in connection with various embodiments of the invention. Such a device generally can be a personal computer, computer workstation (e.g., Sun, HP), laptop computer, server computer, mainframe computer, handheld device (e.g., personal digital assistant, Pocket PC, cellular telephone, etc.), information appliance, printed circuit board with components or any other type of generic or special-purpose, processor-controlled device capable of receiving, processing, displaying, and/or transmitting digital data.

A typical computer includes random access memory (RAM), mechanisms and structures for performing I/O operations, a storage medium such as a magnetic hard disk drive(s), and an operating system (e.g., software) for execution on the central processing unit. The computer also has input and output devices such as a keyboard and monitor, respectively.

A processor generally is logic circuitry that responds to and processes instructions that drive a computer and can include, without limitation, a central processing unit, an arithmetic logic unit, an application specific integrated circuit, a task engine, and/or any combinations, arrangements, or multiples thereof.

Software or code generally refers to computer instructions which, when executed on one or more digital data processing devices, cause interactions with operating parameters, sequence data/parameters, database entries, network connection parameters/data, variables, constants, software libraries, and/or any other elements needed for the proper execution of the instructions, within an execution environment in memory of the digital data processing device(s).

A module is a functional aspect, which may include software and/or hardware. Typically, a module encompasses the necessary components to accomplish a task. It is envisioned that the same hardware could implement a plurality of modules and portions of such hardware being available as needed to accomplish the task. Those of ordinary skill will recognize that the software and various processes discussed herein are merely exemplary of the functionality performed by the disclosed technology and thus such processes and/or their equivalents may be implemented in commercial embodiments in various combinations without materially affecting the operation of the disclosed technology.

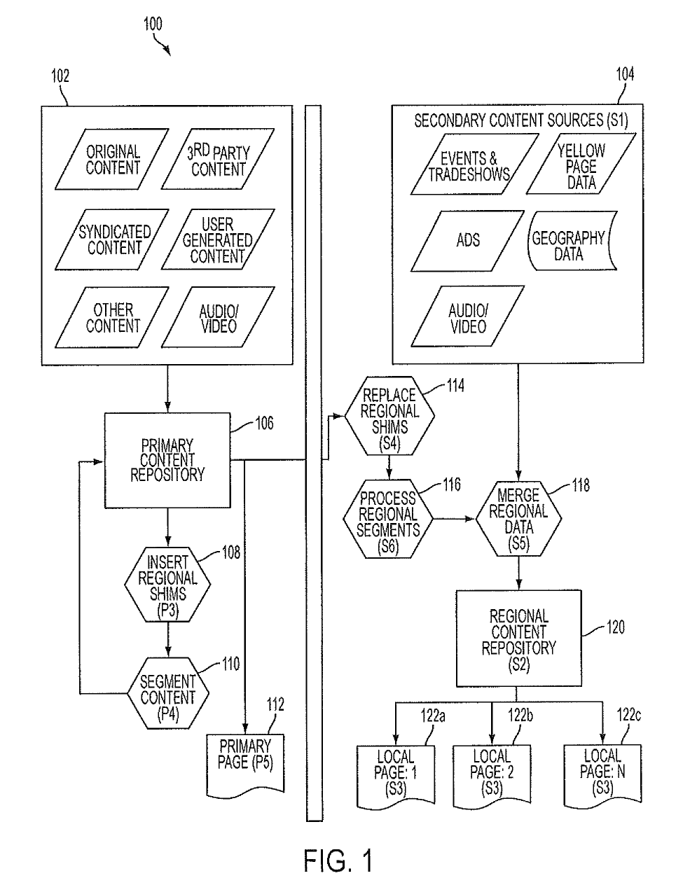

Referring now to FIG. 1, there is illustrated a flowchart 100 depicting a process for regionalizing content and building Web pages specific to a geography, a region, a city, a zip code, a neighborhood, an address, or the like in accordance with an embodiment of the present technology.

The flowchart 100 illustrates a structure or the logic of the present technology, possibly as embodied in computer program software for execution on a computer, digital processor or microprocessor in a distributed computing network such as the Internet or an intranet. Those skilled in the art will appreciate that the flowchart 100 illustrates the structures of the computer program code elements, including logic circuits on an integrated circuit, that function according to the present technology. As such, the present technology may be practiced by a machine component that renders the program code elements in a form that instructs a computer to perform a sequence of function steps corresponding to those shown in the flowchart 100.

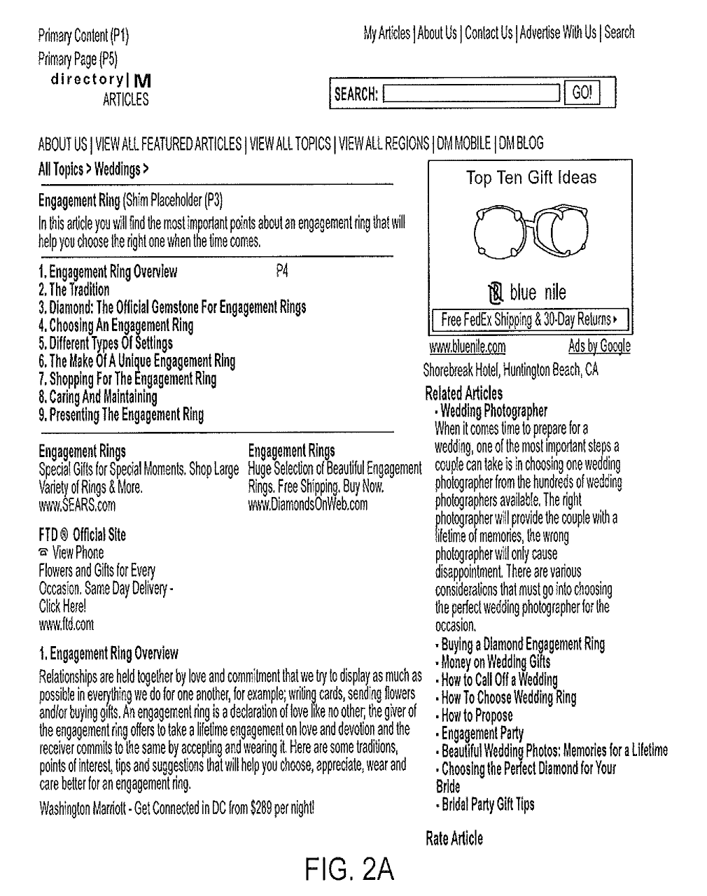

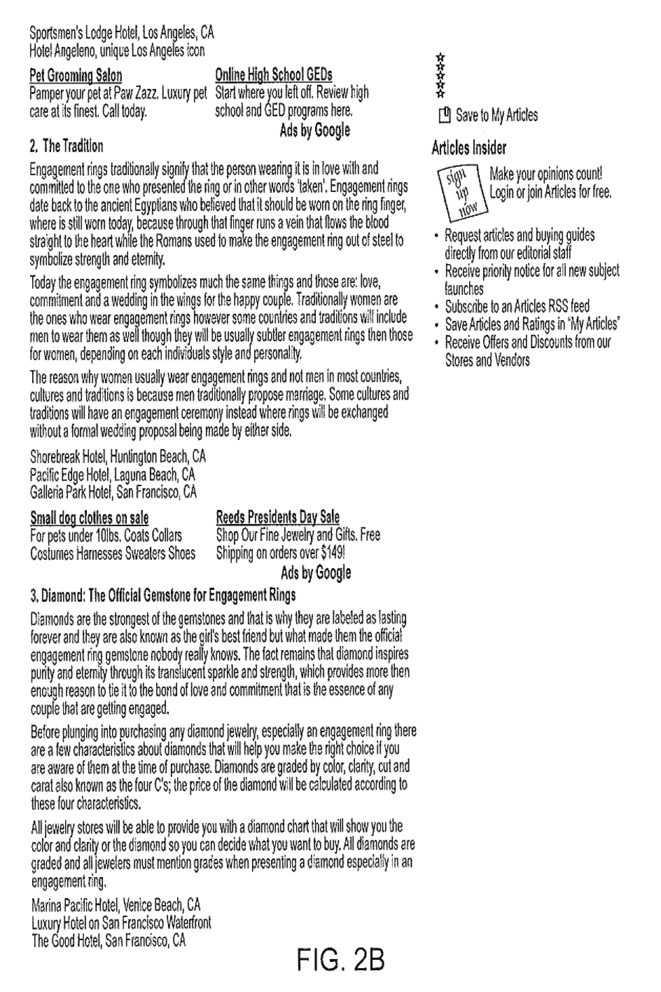

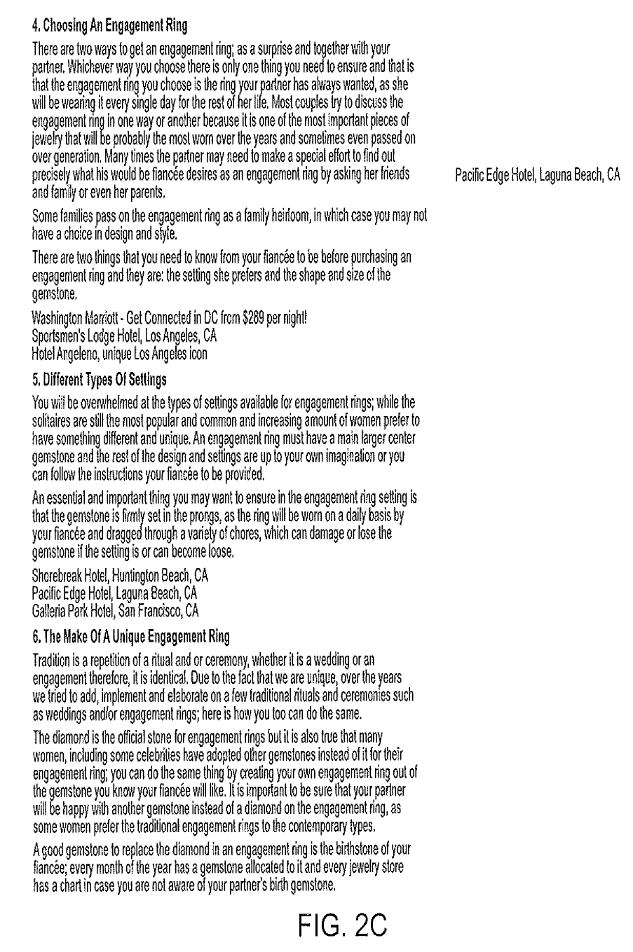

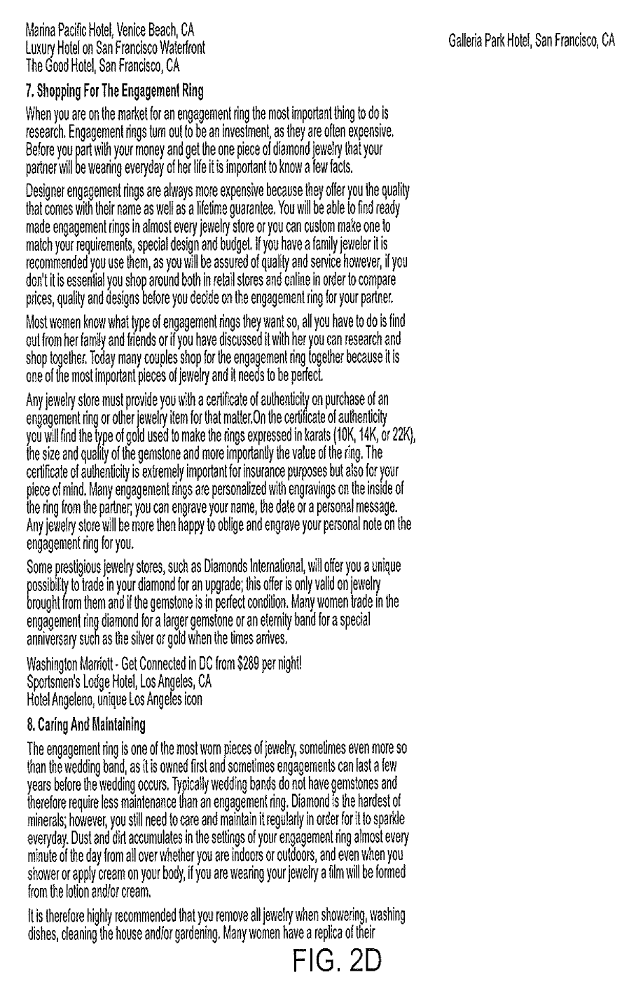

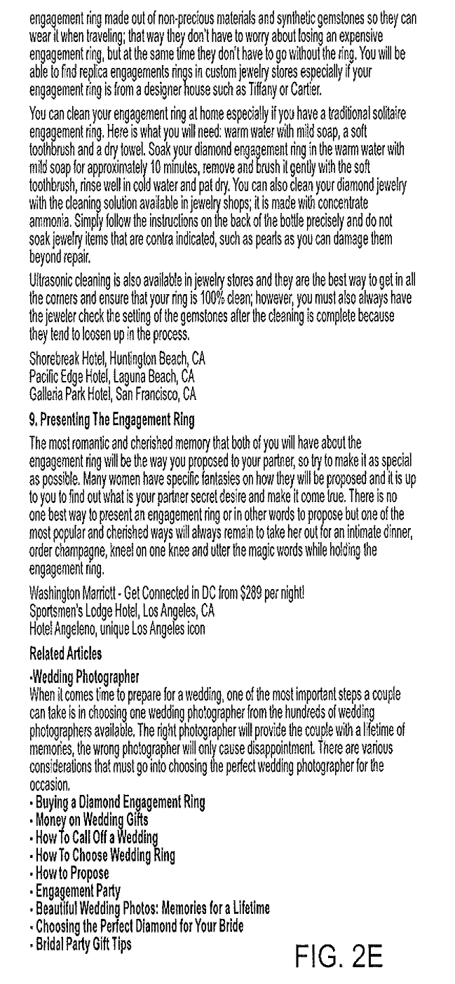

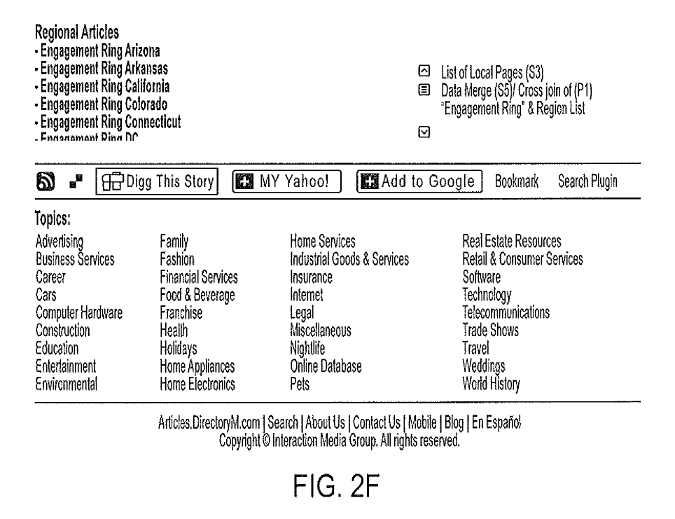

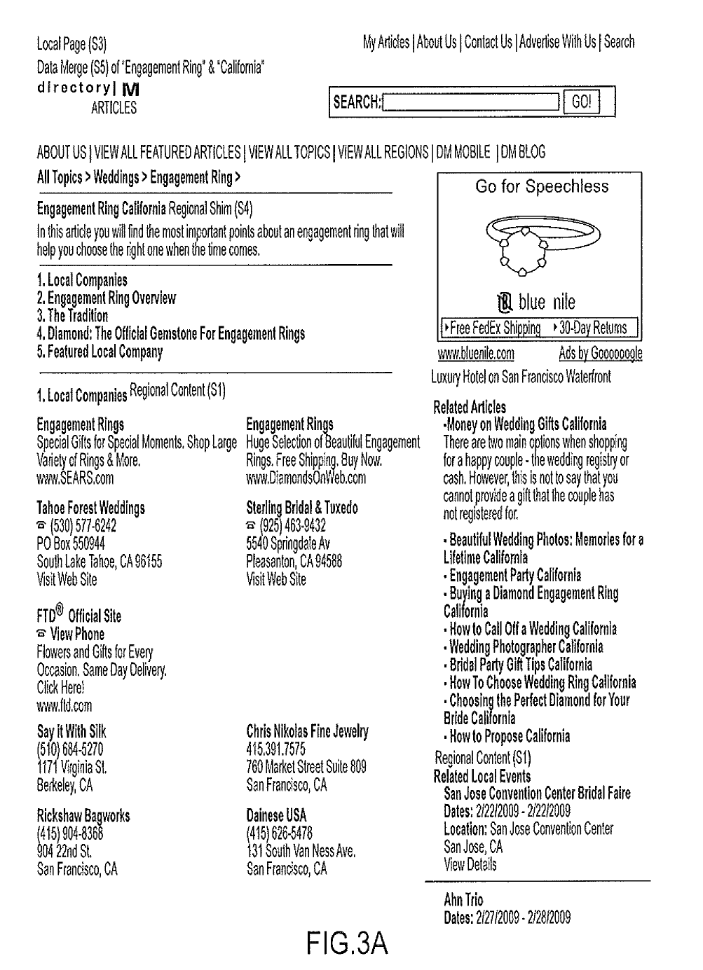

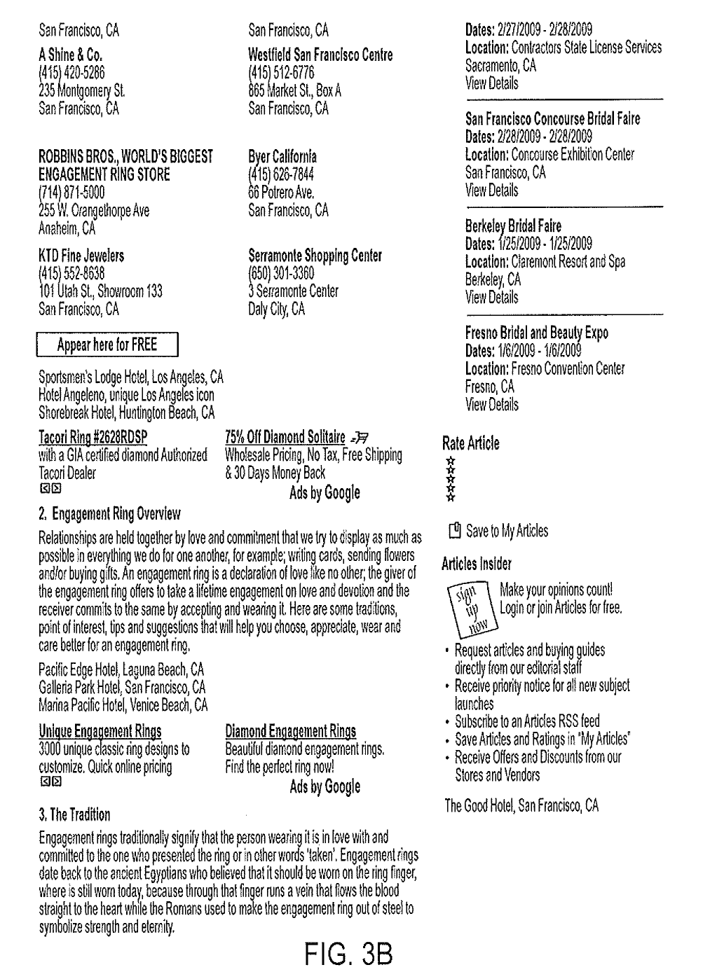

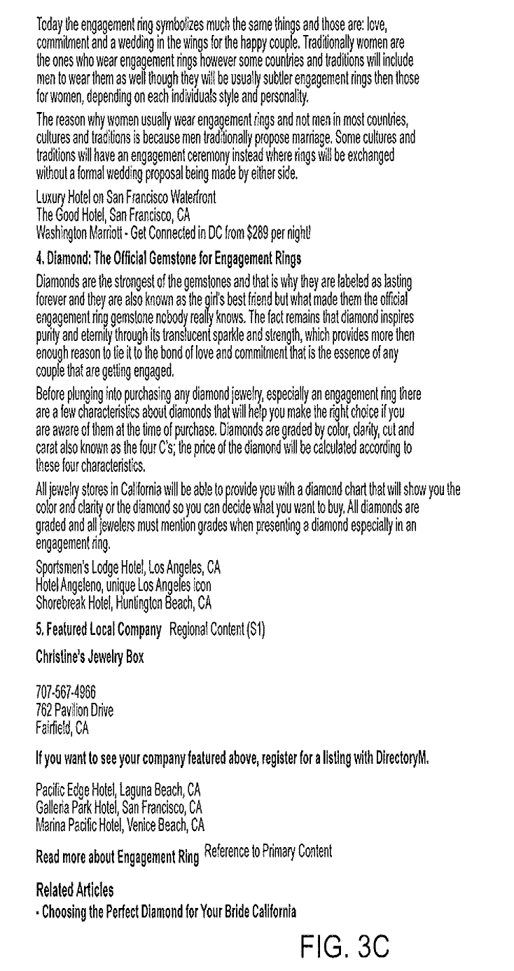

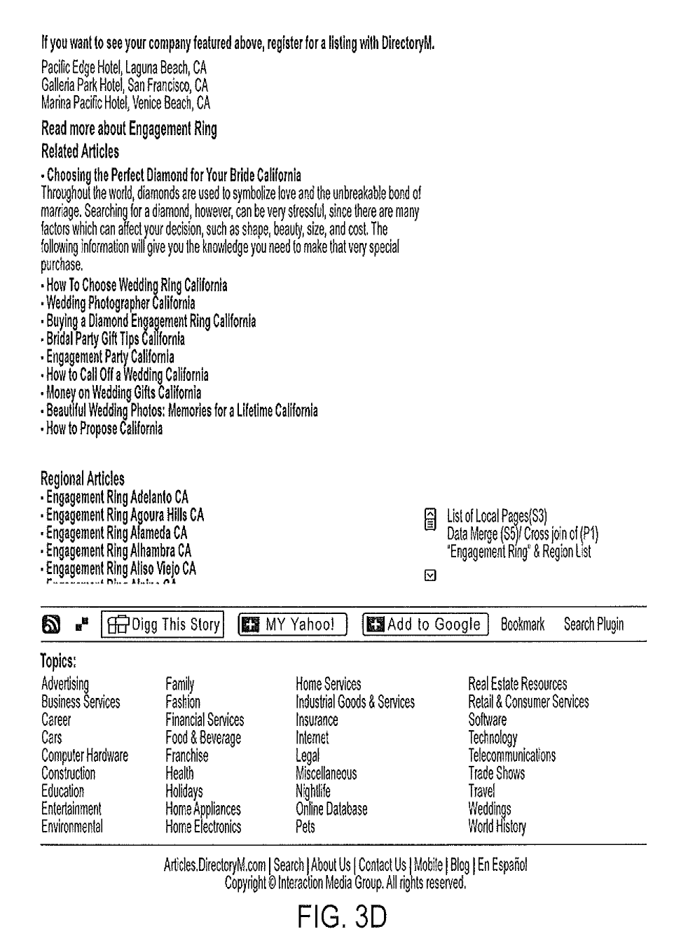

In a preferred embodiment, a company (not shown) hosts a Web site to provide access for users to access the regionalized content, which is discussed below with respect to the FIGS. 2A-3D. It is an object of the flowchart 100 to turn primary content into thousands of geographically relevant pages for publication. FIGS. 2A-F collectively are a Web page of primary content related to engagement rings. The primary content is generally grouped under nine headings. FIGS. 3A-D collectively are a Web page of final content (primary and secondary content) related to engagement rings.

Generally, primary content includes, but is not limited to, original and/or third party articles, industry specific buying guides, product reviews, user generated information, vendor reviews, keywords, topic descriptions, taxonomy overviews, and the like. Basically, any piece of content that is not designed to address local or regional matters is primary content. Primary Content includes, for example, video/audio and images as well as discussion forum and blog posts. Primary content is stored in a primary content module 102.

Secondary or Regional Content includes, but it is not limited to, local yellow page type or other local business data, information on local events, tradeshows, gatherings, information on chambers of commerce, local associations and non-profit organizations. Secondary content also includes local advertisements, user reviews and suggestions on regional businesses. Secondary content can also be topically specific. Secondary content includes local and/or regional reference, whether explicitly or implicitly. As with primary content, secondary content includes video/audio and images as well as discussion forum and blog posts that include local and or regional reference. Secondary content is either stored locally or remotely. Preferably, when the secondary content is stored remotely, the secondary content is accessed in real time or access out-of-line and cached locally. Secondary content is stored in a secondary content module 104.

A local page is a site displayed on the Internet when primary content is combined with secondary content as part of a geography-based taxonomy to create a unique region specific destination. A local page can also be generated without significant primary content by collating multiple items of secondary content that are also topically specific. See item (S3). FIGS. 3A-D are an example of a local page.

The content realization engine, as embodied in a computer, classifies and manipulates the primary content. The primary content may be deposited in a primary content repository (“PCR”) 106, which is designed to accept all the forms of primary content or stored remotely. When the primary content is stored remotely, the content realization engine may access the primary content in real-time or access out-of-line and cache locally. It is envisioned that current primary content in the PCR 106 may be constantly updated by the primary content module 102 as denoted by the flowchart 100. The PCR 106 may be local memory, a disk, a database or the like.

The content realization engine parses the primary content so that the primary content can be presented as subsections in any possible order and logic or as a whole. The content realization engine marks places or “shims” in the Web page text where various secondary content may be sensibly inserted. The content realization engine inserts regional shims into the primary content as shown at step 108. If the primary content includes informational segments, the content realization engine also inserts the informational segments into the primary content as shown as step 110.

As shown in the flowchart, the insertion of shims and placement of information content may be repeated multiple times. The result of the shim insertions along with informational segments amongst the primary content is a primary page as shown at step 112. FIGS. 2A-F are an example of a Web page of primary content.

The primary content may be inserted in the local page with text replacement shims for later processing. The primary content may be displayed in original form as well or processed further as the primary content of FIGS. 2A-F was to produce the Web page of FIGS. 3A-D.

It is also envisioned that the primary content may simply be a topical shell or outline. In the words, the primary content may not have actual content, but may exist only as keywords and/or titles with various shims for placement of secondary content.

The content realization engine also integrates the secondary content into the primary content for publication as a local page. The primary and the secondary content are cross-joined by the content realization engine to create versions of the primary content commingled with the secondary content. Cross-joining is assigning the primary content and the secondary content into groups, which are related. Thus, by using the shims and relationships between the groups, the local page may be assembled.

The content realization engine forms groups and places items in each group. To cross-join, for example, primary content group 1 is joined to each item from secondary group 2 to make a unique combination as shown by example in item S5 in FIG. 3A. The secondary group 2 and other regional or local content is stored in a secondary or regional content repository (SCR) 120. A full cross-join means that given items in the PCR 106 and SCR 120 are combined. Each item from the PCR 106 combines with each item from the SCR 120. However, the content realization engine may not always do a full cross-join. It is envisioned that the content realization engine can perform partial cross-joins at times also.

Still referring to FIG. 1, at step 114, the content realization engine replaces the regional shims in the primary page with the appropriate local tag objects. As shown in FIG. 3A, one local tag object is item S4.

Once the regional shims are replaced, the content realization engine processes the regional segments. Basically the regional segments are formatted for nice rendering and the relevant subset based on geography and category are selected. If appropriate, the content realization engine adds additional object from the secondary content module 104 as shown at step 118. The additional objects from the secondary content may be pre-pended, appended or intermingled into the local page(s). Different secondary content items may be combined or included as part of a local page. A local page may consist of solely or largely secondary items that are topical when the primary content is wholly or largely a shell.

The resulting content is a localized version of the primary content (“local page”) stored in the secondary or regional content repository 120. The localized version contains more information and is better suited as a desired page for a user that has searched for local information as shown in FIGS. 3A-D. The localized version may include one or more local pages with any combination of any number of either primary or secondary content.

The content realization engine also may cross publish primary and local pages. Both the primary and local content can be published under multiple environments. A publication engine can run multiple front ends using different design skins and urls. As the content is separate from the respective display skin, the content can be published under different front-ends that are in operation or will be in future operation. These front ends can be operated for the benefit of the operating organization or can be operated on behalf of third parties.

For example, to host a Web site for a car rental company, the entity executing the process 100 would create and/or receive content related to limousine rental, car rental, and travel. The general content would be processed into primary content with inserted shims. Local content would also be created and/or gathered for insertion. Once the final Web pages are completed, the entity publishes the final content on the World Wide Web for a fee. The fees may be related to content generation and gathering, organizing, publishing, hosting the Web site and the like. Some of the fees may be periodic such as a monthly fee.

In addition to fees associated by publishing the content on the Internet, fees may also be generated by placing ads on the Web site. Further, the company may maintain banner advertisements and links to related Web sites as a source of additional revenue. Preferably, the banner advertisements and links are associated with national and local vendors of medical related goods and services and the company receives a further fee based upon referrals.

While the invention has been described with respect to preferred embodiments, those skilled in the art will readily appreciate that various changes and/or modifications can be made to the invention without departing from the spirit or scope of the invention.

What is claimed is:

1. A method for creating Web pages with a content realization engine embodied in a computer, the method comprising the steps of:
creating and storing primary content that is generally applicable;
inserting shims in the primary content, each shim being a placeholder for secondary content;
creating and storing secondary content that is applicable to a specific topic; and
combining the primary and secondary content by replacing the shims with secondary content to form a Web site directed to the specific topic.

2. A method as recited in claim 1, wherein the specific topic relates to information selected from the group consisting of a regional topic, an industry topic, and combinations thereof.

3. A method as recited in claim 1, classifying the primary content and secondary content into groups such that the shims are replaced by secondary content from a secondary group associated with the primary group that contains the associated shim.

4. A method as recited in claim 1, further comprising the step of displaying the primary content in original form.

5. A method as recited in claim 1, further comprising the step of modifying and displaying the primary content.

6. An engine embodied in a computer for tailoring content to a specific purpose comprising:
a source for primary content;
a primary content repository storing the primary content;
a source for secondary content;
a secondary content repository for storing the secondary content; and
a content generation module to create a primary page having at least one shim that can be replaced with a portion of the secondary content to form at least one specific Web page.

7. An engine as recited in claim 6, wherein the content generation module includes a primary content module and a secondary content module.

8. An engine as recited in claim 6, wherein the secondary content is specific to a particular industry such that an industry specific Web page is created.

9. An engine as recited in claim 6, wherein the secondary content is stored remotely with respect to the primary content.

10. An engine as recited in claim 9, wherein the secondary content is accessed in real time and cached locally.

11. An engine as recited in claim 6, wherein the primary content and secondary content include video/audio and images, discussion forum information, blog posts, local references, and regional references

12. An engine as recited in claim 6, wherein the primary content is a topical shell.
